(19) United States
(12) Patent Application Publication
(10) Pub. No.: US 2014/0259681 A1
(43) Pub. Date: Sep. 18, 2014

(54) APPARATUS FOR PLACING A SEALANT CUTTING WIRE THROUGH A BEAD OF SEALANT IN A GLASS INSTALLATION

(71) Applicant: EQUALIZER INDUSTRIES, INC., Round Rock, TX (US)

(72) Inventors: Eric Asbery, Round Rock, TX (US); Gilbert Gutierrez, Round Rock, TX (US)

(73) Assignee: EQUALIZER INDUSTRIES, INC., Round Rock, TX (US)

(21) Appl. No.: 13/841,690

(22) Filed: Mar. 15, 2013

(51) Int. Cl. B26D 7/26

(52) U.S. Cl. CPC B26D 7/2614
USPC 30/116

(57) ABSTRACT

A cutting wire placement tool includes an elongated tool body, a pulling element carrier structure, and an elongated pulling element. The elongated tool body has a handle end and a sealant piercing end opposite the handle end, and the pulling element carrier structure is located at the sealant piercing end of the elongated tool body. The pulling element carrier structure includes a recess and at least one piercing element having a configuration to pierce a sealant material as a sealant piercing force is applied to the elongated tool body. The elongated pulling element is connected to the elongated tool body at a location spaced apart from the sealant piercing end of the elongated tool body and has a pulling loop which is adapted to be movable between an insertion position and a pulling position relative to the recess of the pulling element carrier structure.

### TECHNICAL FIELD OF THE INVENTION

The present invention relates to tools for removing glass which is sealed in place with a peripheral bead of sealant, particularly auto glass. The invention encompasses a tool which may be used to place a cutting wire through the bead of sealant in the glass installation. The cutting wire may then be used to cut the sealant bead around the periphery of the glass to facilitate removing the glass.

### BACKGROUND OF THE INVENTION

Cutting wire systems have been used in numerous applications to cut through a material which may be difficult to reach with other types of cutting implements. For example, wire saws include a length of cutting wire which may be held at either end by a suitable handle. The handles may be used to move the cutting wire in a sawing motion across the material to be cut. U.S. Pat. No. 4,995,153 shows an example of a wire saw. More recent cutting wire systems use a winching arrangement to simply pull a cutting wire through the material to be cut. The Equalizer® Python™ automotive glass removal system is an example of a system which uses a winching arrangement to pull a cutting wire through a sealant material.

Regardless of how a cutting wire is manipulated to cut through a material, it may be necessary to first place the cutting wire through the material to be cut and then attach the ends to the wire manipulating tool. An auto glass installation is an example of this situation. In an auto glass installation, the glass is placed in a frame of the vehicle and sealed in place with a bead of tough sealant material extending around the entire periphery of the glass. The sealant material seals a space between an inside surface of the glass and a frame in which the glass is set. A particular difficulty in the auto glass situation is that the sealant material is commonly only accessible from inside the vehicle through a thin space between the inside of the glass and the dashboard or other structure inside the vehicle. Furthermore, the sealant in the auto glass installation may be several inches in to the thin opening between the inside surface of the glass and the dashboard or other structure inside the vehicle.

Although there are wire starting tools available for starting a cutting wire through a material to be cut, some of these tools are not useful or not efficient for all situations in which it is desirable for placing a cutting wire through a material to be cut with the wire. Thus there remains a need for devices and techniques for placing a cutting wire through a material to be cut, particularly a material in hard to reach locations such as those found in auto glass installations.

### SUMMARY OF THE INVENTION

A cutting wire placement tool according to one form of the present invention includes an elongated tool body, a pulling element carrier structure, and an elongated pulling element. The elongated tool body has a handle end and a sealant piercing end opposite the handle end, and the pulling element carrier structure is located at the sealant piercing end of the elongated tool body. The pulling element carrier structure includes a recess and at least one piercing element having a configuration to pierce a sealant material as a sealant piercing force is applied axially along the elongated tool body in the direction from the handle end to the sealant piercing end. The elongated pulling element is connected to the elongated tool body at a location spaced apart from the sealant piercing end of the elongated tool body and has a pulling loop which is adapted to be movable between in an insertion position and a pulling position relative to the recess of the pulling element carrier structure. When the pulling loop is in the insertion position a portion of the pulling loop is received in the recess. However, when the pulling loop is in the pulling position, it is adapted to extend beyond the recess at least an operational distance in the direction from the handle end of the elongated tool body to the sealant piercing end.

In operation of this form of the present invention, the elongated tool body is first positioned in a starting position with the sealant piercing end facing a sealant to be cut, and with the pulling loop in the insertion position. From this starting position the tool operator may apply the sealant piercing force to the tool to force the sealant piercing end of the elongated tool body, and particularly the piercing elements at the piercing end of the elongated tool body transversely through the sealant to be cut. As the pulling element carrier structure at the piercing end of the elongated tool body is inserted through the sealant material, the recess supports the pulling loop in the insertion position so that the pulling loop is carried with the pulling element carrier structure through the sealant material. Ultimately, the sealant piercing end of the tool body is pushed completely through the sealant material to a point at which the recess and the pulling loop carried in the recess extends a suitable distance on the opposite side of the sealant material from where the tool was inserted, and the handle end of the elongated tool body remains on the side of the sealant material from which the tool was inserted. From this fully inserted position, the operator may pull the elongated tool body in the opposite direction (opposite to the sealant piercing force) to withdraw the pulling element carrier structure at the sealant piercing end of the tool body to a partially withdrawn position. As the tool is moved to this partially withdrawn position, the pulling loop is free to remain at its position at the point at which the tool was in the fully inserted position. Thus the pulling loop moves to the pulling position relative to the recess of the pulling element carrier structure and is thus exposed on the side of the sealant material opposite to the side from which the tool was inserted. At this point the operator may insert a length of cutting wire through the pulling loop, and then pull the tool completely back through the pierced sealant material to the side from which the tool had been inserted. As the tool is withdrawn, the pulling loop pulls the cutting wire through the sealant material and ultimately places the cutting wire in a position traversing the sealant material. The cutting wire may then be connected to handles or some other suitable manipulating system and may be used to cut the sealant material.

These and other advantages and features of the invention will be apparent from the following description of illustrative embodiments, considered along with the accompanying drawings.

### BRIEF DESCRIPTION OF THE DRAWINGS

FIG. 1 is a front elevation view of a cutting wire placement tool according to one embodiment of the present invention, with the pulling loop in the insertion position.

FIG. 2 is a side elevation of the tool shown in FIG. 1, with the pulling loop in the insertion position.

FIG. 3 is a front elevation view similar to FIG. 1 but with the pulling loop in the pulling position.

FIG. 4 is a front elevation view of the tool shown in FIG. 1, but with the elongated pulling element removed.

FIG. 5 is a view of the removed elongated pulling element employed in the embodiment shown in FIG. 1.

FIG. 6 is an enlarged front elevation view of just the pulling element carrier structure of the embodiment shown in FIG. 1.

FIG. 7 is a side elevation view of the pulling element carrier structure shown in FIG. 6.

FIG. 8 is an end elevation view of the pulling element carrier structure shown in FIGS. 6 and 7.

FIG. 9 is a front elevation view of the tool embodiment shown in FIG. 1 in a starting position for placing a cutting wire through a sealant material to be cut.

FIG. 10 is a front elevation view similar to FIG. 9 but with the sealant piercing end of the tool inserted through the sealant material.

FIG. 11 is a front elevation view similar to FIG. 9 but with the tool partially withdrawn from the sealant material and with the pulling loop in position to receive a cutting wire.

FIG. 12 is a front elevation view similar to FIG. 9 but with the tool fully withdrawn from the sealant material so as to place the cutting wire through the sealant material.

### DESCRIPTION OF ILLUSTRATIVE EMBODIMENTS

The claims at the end of this application set out novel features which the Applicants believe are characteristic of the invention. The various advantages and features of the invention together with preferred modes of use of the invention will best be understood by reference to the following description of illustrative embodiments read in conjunction with the drawings introduced above.

In the following description, FIGS. 1 through 8 will first be referenced to describe an embodiment of the present invention. The operation of this embodiment to place a cutting wire will then be described with reference to FIGS. 9 through 12.

Referring to FIGS. 1 through 5, a cutting wire placement tool 101 according to one embodiment of the invention includes an elongated tool body 102 which extends from a handle end 104 to a sealant piercing end 105. Tool 101 includes a handle 106 attached to the elongated tool body 102 at the handle end 104. As shown in FIGS. 1 and 2, elongated tool body 102 extends along a longitudinal axis L.

Tool 101 includes a pulling element carrier structure 108 located at sealant piercing end 105 of elongated tool body 102. Pulling element carrier structure 108 includes a recess 109 and piercing elements 110 (which although shown in FIGS. 1 through 3, are better shown in the enlarged views of FIGS. 6-8).

Tool 101 also includes an elongated pulling element 112. Elongated pulling element 112 includes a pulling loop 114 at one end, and the opposite end is connected to elongated tool body 102. In this particular embodiment, elongated pulling element 112 comprises a loop of suitable wire material and pulling loop 114 comprises simply one end of the loop of wire material. The connection between elongated tool body 102 and elongated pulling element 112 in this particular embodiment is made through a slot 115 formed in the elongated tool body at a position between sealant piercing end 105 and handle end 104. The loop of wire comprising elongated pulling element 112 in this embodiment simply extends through elongated slot 115 to form the connection between the elongated pulling element and elongated tool body 102.

In the particular embodiment shown in the figures, elongated tool body 102 may comprise a length of flat spring steel approximately ½ mm thick and approximately 1 foot long between handle end 104 and sealant piercing end 105. It will be appreciated that the side view of FIG. 2 shows the thickness of elongated tool body 102 somewhat exaggerated due to the scale of the drawing. Elongated tool body 102 may be approximately 1 inch wide at handle end 104 and taper down to approximately 3 to 4 mm wide at sealant piercing end 105. Slot 115 may be approximately 2 inches long and may have an end nearest sealant piercing end 105 spaced apart from that end approximately 5 inches. It should be appreciated that these dimensions are provided only for purposes of example and are not intended to be limiting. These tool dimensions have particular application to tools intended for placing a cutting wire through a bead of auto glass sealant in an auto glass installation as a step preparatory to cutting the sealant with the cutting wire.

FIG. 1 shows tool 101 with pulling loop 114 in an insertion position. In this insertion position a portion of pulling loop 114 is received in recess 109 and the opposite end of elongated pulling element 112 is shifted toward handle end 104 so as to reside near the end of elongated slot 115 which is nearest handle end 104. As will be described below in connection with FIG. 9, pulling loop 114 is placed in this insertion position shown in FIG. 1 preparatory to insert sealant piercing end 105 through a sealant material in the process of placing a cutting wire through the sealant material.

FIG. 3 shows tool 101 with pulling loop 114 in a pulling position. In this pulling position, elongated pulling element 112 is shifted in the direction from handle end 104 to sealant piercing end 105 so that pulling loop 114 extends at least an operational distance from recess 109. It will also be noted that when pulling loop 114 is in the pulling position shown in FIG. 3, the opposite and of elongated pulling element 112 is shifted downwardly in the orientation of the figure so as to reside at an end of elongated slot 115 which is nearest sealant piercing end 105 of elongated tool body 102. As will be described below in connection with FIG. 11, pulling loop 114 moves to the pulling position to receive a length of cutting wire in the process of placing the cutting wire through a sealant material to be cut. The operational distance that pulling loop 114 extends beyond recess 109 is a distance sufficient to receive a length cutting wire there through. This may be as little as one-quarter inch in some cases. More preferably the operational distance that pulling loop 114 extends beyond recess 109 when the pulling loop is in the pulling position is approximately two inches, that is, two inches plus or minus one-half inch.

FIG. 5 shows elongated pulling element 112 removed from elongated tool body 102, while FIG. 4 shows the elongated tool body without the elongated pulling element. Any suitable technique may be used to secure the wire material which makes up elongated pulling element 112 through slot 115 to secure the wire material to elongated tool body 102.

FIGS. 6-8 show further details of pulling element carrier structure 108 employed in the embodiment of the invention shown in FIGS. 1-4. In this embodiment, the material making up elongated tool body 102 at the sealant piercing end 105 is sharpened or otherwise tapered to a point to make it easier for the tool to pierce a sealant material to be cut. Recess 109 in this embodiment comprises a notch machined or otherwise formed at the piercing end 105 so as to form two spaced apart piercing elements 110 with a recess surface 111 formed there between. Recess 109 is sized so as to receive a portion of pulling loop 114 (a section of which is shown in dashed lines in FIG. 6).

FIGS. 9 through 12 may now be used (with reference to the enlarged views of FIGS. 6 through 8 for details of pulling element carrier structure 108) to describe the operation of tool 101 to place a cutting wire through a sealant material 118 to be cut with the wire. It will be appreciated by those skilled in the art of auto glass removal and installation that such a bead of sealant is commonly used to seal around the periphery of a vehicle windshield between the inside surface of the glass and a pinch weld frame within which the glass rests. In this application of rule 101, the position of sealant material 118 and tool 101 shown in FIGS. 9 through 12 is generally a plan view looking through the glass from outside to the inside of the vehicle. The glass itself and pinch weld frame are not shown in this illustration in order to more clearly show the operation of the tool 101 according to the invention.

FIG. 9 shows the position and condition of tool 101 in a starting position. In this starting position shown in FIG. 9, pulling loop 114 is placed in the inserted position in recess 109.

From the position of tool 101 relative to sealant material 118 shown in FIG. 9, tool 101 is moved downwardly in the orientation of the figure with sufficient force (a sealant piercing force) to cause piercing elements 110 of pulling element carrier structure 108 to pierce the sealant material and extend a suitable distance on the other side of the sealant material from the side at which the tool was inserted. This suitably inserted position is shown in FIG. 10. As pulling element carrier structure 108 was inserted through sealant material 118 to move from the position of FIG. 9 to the position of FIG. 10, the surface of recess 109 supported the portion of the pulling loop 114 received therein and pushed or carried that portion of pulling loop 114 through the sealant material and to the position shown in FIG. 5.

From the position shown in FIG. 10, tool 101 may be withdrawn back through sealant material 118 to the partially withdrawn position shown in FIG. 11. Since elongated pulling element 112 is free to move at least the length of elongated slot 115 relative to elongated tool body 102, and due to friction between sealant material 118 and the portion of elongated pulling element 112 exposed to the sealant material, pulling loop 114 remains on the opposite side of sealant material 118. Thus as tool 101 is withdrawn from the position of FIG. 10 to the position of FIG. 11, pulling loop 114 moves from the insertion position relative to recess 109 to the pulling position shown in FIG. 11. The exposed portion of pulling loop 114 on the opposite side of sealant 118 from the side through which the tool 101 was inserted forms a loop through which a length of cutting wire 120 may be extended as shown in FIG. 11. Once cutting wire 120 is positioned through pulling loop 114, tool 101 may be withdrawn further from sealant material 118. Ultimately, pulling loop 114 and the length of cutting wire 120 carried by the pulling loop is pulled to the starting side of the sealant material through which tool 101 was originally inserted. This places the cutting wire in the desired position traversing the sealant material 118 as shown in FIG. 12. From this position an end of cutting wire 120 on either side of sealant material 118 may be connected to a suitable manipulating tool or other tool and may be used to cut the sealant material around the periphery of the windshield.

Although tool 101 shown in the figures represents one preferred embodiment of a cutting wire placement tool according to the present invention, numerous variations on this exemplary structure are possible within the scope of the invention. For example, although elongated tool body 102 comprises a flat material, other cross-sectional shapes may be used. Alternative tools within the scope of the following claims may have a tool body with a circular cross-sectional shape. Of course, the invention is also not limited to any particular type of handle for the tool. Although a T-shaped handle is shown for purposes of example, other handles may have a pistol grip configuration with all or the majority of finger gripping positions on one side of the elongated tool body.

The present invention also includes many variations in the configuration of the pulling element carrier structure. It should be appreciated that also the bottom surface of recess 109 is shown as a cylindrical surface which meets the intersecting faces of the elongated tool body 102 at abrupt angles, forms of the invention may included a rounded transition from the surface forming the bottom of recess 109 to the intersecting planar faces of the elongated tool body. Also, the transitioning surfaces may include a groove generally aligned with the longitudinal axis L to receive the pulling loop material. It is preferable that the bottom surface of recess 109 not comprise a sharp edge which could crimp or sever the pulling loop material as the tool is inserted through the sealant to be cut.

Other variations are associated with the elongated pulling element. Although the example tool 101 includes pulling element 112 comprising a loop of suitable high tensile strength wire or cable, an alternative elongated pulling element may include a rigid rod of material which is connected at one end so as to be slidable in slot 115. Alternatively, the elongated pulling element may include a flexible material having an upper end (in the orientation of the figures) which is not received in a slot, but rather received at a fixed location. In these embodiments, the flexibility of the elongated pulling element allows the pulling loop part to move relative to the recess (such as recess 109 in the figures) between the insertion position and pulling position.

As used herein, whether in the above description or the following claims, the terms “comprising,” “including,” “carrying,” “having,” “containing,” “involving,” and the like are to be understood to be open-ended, that is, to mean including but not limited to. Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above described preferred embodiments are intended to illustrate the principles of the invention, but not to limit the scope of the invention. Various other embodiments and modifications to these preferred embodiments may be made by those skilled in the art without departing from the scope of the present invention.

1. An apparatus for placing a sealant cutting wire through a sealant material, the apparatus including:
(a) an elongated tool body having a handle end and a sealant piercing end opposite the handle end;
(b) a pulling element carrier structure located at the sealant piercing end of the elongated tool body, the pulling element carrier structure including a recess and at least one piercing element having a configuration to pierce a sealant material as a sealant piercing force is applied axially along the elongated tool body in the direction from the handle end to the sealant piercing end; and
(c) an elongated pulling element connected to the elongated tool body at a location spaced apart from the sealant piercing end of the elongated tool body and having a pulling loop which is adapted to be movable between an insertion position and a pulling position relative to the pulling element carrier structure, a portion of the pulling loop (i) being received in the recess when the pulling loop is in the insertion position and (ii) being adapted to extend beyond the recess at least an operational distance in the direction from the handle end of the elongated tool body to the sealant piercing end when the pulling loop is in the pulling position.

2. The apparatus of claim 1 wherein the elongated tool body includes a length of rigid flat material which narrows in the plane of the material from the handle end to the sealant piercing end.

3. The apparatus of claim 1 wherein the recess is formed between two piercing elements.

4. The apparatus of claim 1 wherein the elongated pulling element comprises a loop of wire and the pulling loop represents one end of the loop of wire making up the elongated pulling element.

5. The apparatus of claim 1 wherein the tool body includes an elongated slot formed therein between the handle end and the sealant piercing end, the elongated slot having a longitudinal axis aligned with the longitudinal axis of the elongated tool body, and wherein the elongated pulling element extends through the slot to connect to the elongated tool body.

6. The apparatus of claim 5 wherein when the elongated pulling element is in the insertion position at an end of the elongated pulling element opposite to an end including the pulling loop is located at an end of the slot nearest the handle end of the elongated tool body.

7. The apparatus of claim 5 wherein when the elongated pulling element is in the pulling position the portion of the pulling loop that was received in the recess when in the insertion position is spaced apart from the recess by approximately the length of the slot, and the end of the elongated pulling element opposite to the end including the pulling loop is located at an end of the slot nearest the sealant piercing end of the elongated tool body.

8. The apparatus of claim 1 wherein the pulling loop comprises a closed loop of wire.

9. An apparatus for placing a sealant cutting wire through a sealant material, the apparatus including:
(a) an elongated tool body having a handle end and a sealant piercing end opposite the handle end;
(b) a pulling element carrier structure located at the sealant piercing end of the elongated tool body, the pulling element carrier structure including a recess and at least one piercing element having a configuration to pierce a sealant material as a sealant piercing force is applied axially along the elongated tool body in the direction from the handle end to the sealant piercing end, the recess including a support surface which extends transverse to the longitudinal axis of the elongated tool body; and
(c) an elongated pulling element having a first end including a pulling loop and an opposite second end which is connected to the elongated tool body at a location spaced apart from the sealant piercing end of the elongated tool body, the pulling loop being adapted to be movable between an insertion position and a pulling position relative to the pulling element carrier structure, a portion of the pulling loop (i) being received in the recess and abutting the support surface when the pulling loop is in the insertion position and (ii) being adapted to extend beyond the recess at least an operational distance in the direction from the handle end of the elongated tool body to the sealant piercing end when the pulling loop is in the pulling position.

10. The apparatus of claim 9 wherein the elongated tool body includes a length of rigid flat material which narrows in the plane of the material from the handle end to the sealant piercing end.

11. The apparatus of claim 9 wherein the recess is formed between two piercing elements.

12. The apparatus of claim 9 wherein the elongated pulling element comprises a loop of wire and the pulling loop represents one end of the loop of wire making up the elongated pulling element.

13. The apparatus of claim 9 wherein the tool body includes an elongated slot formed therein between the handle end and the sealant piercing end, the elongated slot having a longitudinal axis aligned with the longitudinal axis of the elongated tool body, and wherein the elongated pulling element extends through the slot to connect to the elongated tool body.

14. The apparatus of claim 13 wherein when the elongated pulling element is in the insertion position at an end of the elongated pulling element opposite to an end including the pulling loop is located at an end of the slot nearest the handle end of the elongated tool body.

15. The apparatus of claim 13 wherein when the elongated pulling element is in the pulling position the portion of the pulling loop that was received in the recess when in the insertion position is spaced apart from the recess by approximately the length of the slot, and the end of the elongated pulling element opposite to the end including the pulling loop is located at an end of the slot nearest the sealant piercing end of the elongated tool body.

16. The apparatus of claim 9 wherein the pulling loop comprises a closed loop of wire.
